(19) United States
(12) Patent Application Publication
(10) Pub. No.: US 2019/0384080 A1
(43) Pub. Date: Dec. 19, 2019

(54) LIQUID CRYSTAL PANEL AND THE MANUFACTURING METHOD THEREOF

(71) Applicant: HUIZHOU CHINA STAR OPTOELECTRIC TECHNOLOGY CO., LTD., Huizhou Guangdong (CN)

(72) Inventor: Xiaohong JING, Huizhou Guangdong (CN)

(21) Appl. No.: 15/752,565

(22) PCT Filed: Jan. 18, 2018
(86) PCT No.: PCT/CN2018/073170

§ 371 Date: Nov. 16, 2018

(30) Foreign Application Priority Data
Dec. 28, 2017 (CN) 201711462300.1

(51) Int. Cl. G02F 1/1339; G02F 1/1335

(52) U.S. Cl. CPC G02F 1/1339; G02F 1/133514; G02F 1/133528

(57) ABSTRACT

Disclosed is a LCD panel including a TFT substrate, a CF substrate, liquid crystals filled between TFT substrate and CF substrate, and a first polarizer adhered to outer surface of CF substrate. One end of the TFT substrate extends beyond CF substrate to form a bonding end for connecting to a COF. The first polarizer completely covers TFT substrate and a sealing adhesive is provided between first polarizer and bonding end and to the side surface of bonding end. The portion of COF close to the side of bonding end is enclosed in sealing adhesive. Also disclosed is a manufacturing method for LCD panel featuring by connecting bonding end to COF and adhering first polarizer. This eliminates the printing process to the external TFT substrate and does not require to perform adhesive dispensing and filling operation to the bare bonding end, thereby reducing cost and simplifying process.

The present application is a National Phase of International Application Number PCT/CN2018/073170, filed Jan. 18, 2018, and claims the priority of China Application No. 201711462300.1, filed Dec. 28, 2017.

### FIELD OF THE DISCLOSURE

The invention relates to the field of display technology, and more particularly to a liquid crystal panel and the manufacturing method thereof.

### BACKGROUND

The bezel-less mechanical appearance of a liquid crystal display (LCD) has become a popular trend in the design industry of display. A bezel-less display is a display with an extremely narrow bezel on the periphery of the display screen, and is designed in a manner that the user can not visualize the physical bezel of the display when the display screen and the bezel come to integration. One of the advantages of a bezel-less display is attributed to its an outstanding ornamental feature. Compared to the conventional thick-bezel display, a bezel-less display can offer the user with a real horizontal display screen to render a sense of fashion for user. Another advantage of a bezel-less display is that multiple bezel-less displays can be joined together to form a two-fold, three-fold, or a multiple-fold display screen. Moreover, a bezel-less display can optimize the visuality of a joined display screen. Besides, a bezel-less display can offer the user with a wider visual effect and eliminate the sense of bondage that exists in the conventional thick-bezel display.

A liquid crystal display consists of a LCD panel and a backlight module. The bezel-less design of the contemporary liquid crystal display is accomplished by removing the front bezel and the front casing of the whole machine. A LCD panel generally includes a color filter (CF) substrate and an array substrate (thin-film transistor array substrate, or simply TFT substrate). These two substrates are oppositely juxtaposed with each other and liquid crystals are filled between these two substrates. In prior art, there are two design modes for the design of bezel-less liquid crystal display.

The first design mode is to set the external CF substrate as the viewing plane. In this mode, the CF substrate is disposed atop a TFT substrate, and a polarizer is disposed on the CF substrate. Because the TFT substrate is connected to a chip on film (COF) after the CF substrate and the polarizer are mounted, the bonding end of the TFT substrate connecting to the COF must extend beyond the CF substrate and the polarizer disposed thereon. This would require the bonding end of the TFT substrate to be processed after the bonding end of the TFT substrate is finally connected to the COF. Generally, such processing is performed with the adhesive dispensing and filling process. However, if the adhesive dispensing and filling process is carried out manually, the uniformity of the adhesive dispensing is quite poor as workers tend to arbitrarily dispense the adhesive. Hence, it is difficult to stipulate a standard manufacturing procedure. What is worse, the volatility of the adhesive dispensing would be quite poor. Thus, the manual adhesive dispensing and filling process can not meet the requirements on accuracy, which would degrade the yield of the LCD panel and retard the manufacturing efficiency. On the other hand, if we use an adhesive dispenser to dispense adhesive, the manufacturing cost of the LCD panel would be heightened as the adhesive dispenser is a costly equipment for adhesive dispensing process.

The second design mode is to set the external TFT substrate as the viewing plane. In this mode, after the bonding end of the TFT substrate is connected to the COF, the metal wires on the bonding end would cause optical affection to the LCD panel. Therefore, it is necessary to perform a printing process to the outer periphery of the TFT substrate. This would complicate the manufacturing process of the LCD panel and escalate the manufacturing cost of the LCD panel.

The aforementioned two design modes both have defects that would impede the widespread promotion and popularity of the bezel-less display.

### SUMMARY

In view of the defects lingering in the prior art, the invention provides a LCD panel and the manufacturing method thereof to attain a cheap and easy-to-manufacture bezel-less LCD panel.

To this end, the invention employs a technological scheme as set forth below:

The invention provides a LCD panel including a thin-film transistor (TFT) substrate, a color filter (CF) substrate disposed on the TFT substrate, liquid crystals filled between the TFT substrate and the CF substrate, and a first polarizer adhered to the outer surface of the CF substrate. At least one end of the TFT substrate extends beyond one end of the CF substrate to form a bonding end for connecting to a chip on film (COF). The first polarizer completely covers the TFT substrate. A sealing adhesive is provided between the first polarizer and the bonding end and to a side surface of the bonding end. The portion of the COF which is close to the side surface of the bonding end is enclosed in the sealing adhesive.

In accordance with one embodiment of the invention, a surface of the bonding end opposite to the first polarizer is provided with a groove, and the groove is filled with the sealing adhesive.

In accordance with one embodiment of the invention, the bonding end is laminated with an anisotropic conductive film. The chip on film is electrically connected to the conductive terminals of the bonding end through the anisotropic conductive film.

In accordance with one embodiment of the invention, the sealing adhesive includes a first sealing adhesive formed by melting down a thermoplastic film and/or a second sealing adhesive which is laterally injected by a panel edge coater.

Another object of the invention is to provide a manufacturing method for a LCD panel, which includes the steps of:

cutting a mother plate to form a liquid crystal cell, in which a salient portion of a TFT substrate of the liquid crystal cell forms a bonding end;

electrically connecting a chip on film (COF) to the bonding end;

adhering a first polarizer to an outer surface of a color filter substrate (CF substrate) so as to form a cavity between the first polarizer and the bonding end; and

laterally sealing the cavity and a side of the bonding end.

In accordance with one embodiment of the invention, the step of laterally sealing is accomplished by using a panel edge coater to laterally inject a second sealing adhesive.

Another yet object of the invention is to provide a manufacturing method for a LCD panel, which includes the steps of:

cutting a mother plate to form a liquid crystal cell, in which a salient portion of a TFT substrate of the liquid crystal cell forms a bonding end;

electrically connecting a chip on film (COF) to the bonding end;

adhering a thermoplastic film to the bonding end;

disposing a first polarizer on a color filter (CF) substrate to enable the first polarizer to contact the thermoplastic film;

vacuum hot-pressing the first polarizer to adhere the first polarizer to an outer surface of the CF substrate, while melting down the thermoplastic film so as to fill a cavity between the first polarizer and the bonding end;

irradiating the filled thermoplastic film with UV light to cure it; and

laterally sealing the cavity and the side of the bonding end.

In accordance with one embodiment of the invention, one surface of the thermoplastic film protrudes from the surface of the CF substrate before the vacuum hot-pressing process.

In accordance with one embodiment of the invention, the thermoplastic film is melted down to form a first sealing adhesive;

In accordance with one embodiment of the invention, the lateral sealing process is carried out by laterally injecting a second sealing adhesive by a panel edge coater.

Compared to the prior art, the invention provides a LCD panel that takes the polarizer on the CF substrate as a viewing plane. The bonding end of the LCD panel is located between the polarizer and the TFT panel, and the first sealing adhesive formed by melting down a thermoplastic film or a second adhesive is laterally injected to fill between the polarizer and the TFT substrate. Thus, the invention does not need to set up a bezel to shade the bonding end, so as to achieve a bezel-less design for enhancing the overall visual effect and promoting viewing experience. In the meantime, in case that a LCD panel of the same width is used, the arrangement of the groove on the LCD panel can make the connection between the polarizer and the TFT substrate secure. The manufacturing method for LCD panel according to the invention is featured by first connecting the bonding end to the COF and adhering a polarizer to the outer surface of the external CF substrate. This would eliminate the need of dispensing and filling adhesive to the bare bonding end. Thus, the manufacturing cost of the LCD panel is reduced and the printing process for the external TFT substrate can be omitted, thereby simplifying the manufacturing process.

### BRIEF DESCRIPTION OF THE DRAWINGS

FIG. 1 is a schematic diagram showing the structure of a LCD panel before the lateral sealing process is accomplished according to embodiment 1 of the invention;

FIG. 2 is a schematic diagram showing the structure of a LCD panel after the lateral sealing process is accomplished according to embodiment 1 of the invention;

FIG. 3 is a flow chart illustrating the manufacturing process of a LCD panel according to embodiment 1 of the invention;

FIG. 4 is a schematic diagram showing the structure of a LCD panel before the polarizer is adhered thereto according to embodiment 2 of the invention;

FIG. 5 is a schematic diagram showing the structure of a LCD panel after the polarizer is adhered thereto according to embodiment 2 of the invention;

FIG. 6 is a schematic diagram showing the structure of a LCD panel after the lateral sealing process is accomplished according to embodiment 2 of the invention; and

FIG. 7 is a flow chart illustrating the manufacturing process of a LCD panel according to embodiment 2 of the invention.

### DETAILED DESCRIPTION OF PREFERRED EMBODIMENTS

In order to clarify the objects, technological scheme, and advantages of the invention, the invention will be described in detail by the following embodiments and accompanying drawings. It should be understood that the concrete embodiments disclosed herein are merely for the purpose of expounding the invention, without the intention to limit the scope of the invention.

### Embodiment 1

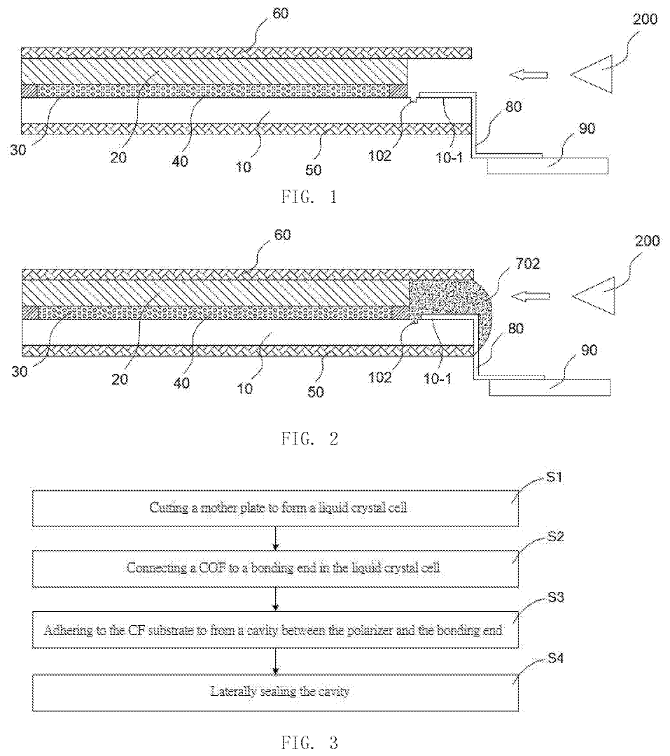

Please refer to FIG. 1 and FIG. 2. An embodiment of the invention provides a LCD panel, which includes a TFT (thin-film transistor) substrate 10 opposite to the backlight module, a color filter (CF) substrate 20 disposed on the TFT substrate 10, and liquid crystals 40 interposed between the TFT substrate 10 and the CF substrate 20. The liquid crystals 40 can be sealed between the TFT substrate 10 and the CF substrate 20 by an adhesive 30. A second polarizer 50 and a first polarizer 60 are respectively adhered to the outer surface of the TFT substrate 10 and the outer surface of the CF substrate 20.

Each side of the CF substrate 20 which is disposed on the adhesive 30 is aligned with each side of the adhesive 30. It can be understood that the region of the liquid crystals 40 forms the display region of the LCD panel. To arrange the bonding end of the LCD panel, at least one side of the TFT substrate 10 must extend beyond a side surface of the CF substrate 20. Certainly, at least one side of the TFT substrate 10 must extend beyond the adhesive 30 as well. The salient portion of the TFT substrate 10 forms a bonding end 10-1 for connecting to a chip on film (COF) rather than for the purpose of display. In this architecture, the first polarizer 60 on the CF substrate 20 is taken as a viewing plane. Hence, the shape and dimension of the first polarizer 60 is conformable to the TFT substrate 10, such that the first polarizer 60 completely covers the TFT substrate 10. It can be understood that the first polarizer 60 is salient with respect to the CF substrate 20. The first polarizer 60, the side of the adhesive 30, and the side of the CF substrate 20 constitute a cavity having an opening, in which the cavity is filled with a sealing adhesive to facilitate the packaging of the LCD panel.

The sealing adhesive can not only seal the LCD panel, but also can shade the bonding end 10-1. As the bonding end 10-1 is required to provide conductive terminals thereon, a lot of metal wires are laid out on the bonding end. The metal wires may be configured as a fanout, a WOA (wire on array), or a GOA (gate on array) wiring. The density of the metal wiring pattern of these metal wires is relatively large, which would conspicuously cause reflective glare and seriously affect the overall visual effect. To block such reflective glare, these metal wires must be shaded after the wiring is completed. The sealing adhesive can not only securely connect the first polarizer 60 to the TFT substrate 10, but also can shade the wires on the bonding end 10-1. This configuration allows the sealing and shading function to be done concurrently with simple manufacturing process and simplified technique.

Concretely speaking, the filling process according to embodiment 1 is described as follows. In FIG. 1 and FIG. 2, the sealing adhesive for use in filling is a second sealing adhesive 702, which is laterally injected by a panel edge coater 200. After the first polarizer 60 is adhered, the second sealing adhesive 702 is laterally injected into the cavity of the LCD panel by the panel edge coater 200, thereby filling and sealing the cavity. In this case, the sealing adhesive can be extended to enclose the portion of the COF 80 close to the side surface of the bonding end 10-1, thereby providing a certain level of protection for the COF 80.

In FIG. 1 and FIG. 2, in order to secure the connection between the first polarizer 60 and the TFT substrate 10, a groove 102 may be arranged on the surface of the bonding end 10-1 opposite to the first polarizer 60. This groove concaves downwards from the top surface of the TFT substrate 10. It can be understood that the concave groove 102 can communicate with the cavity between the first polarizer 60 and the TFT substrate 10. This can enhance the fastening between the first polarizer 60 and the TFT substrate 10 on the basis that the width of the non-display area is diminished. In addition, in order to minimize the width of the non-display area without affecting the fastening between the first polarizer 60 and the TFT substrate 10, the number of the groove can be more than one. In this case, a second sealing adhesive 702 is dispensed in multiple grooves so as to shrink the non-display area and enhance the fastening between the first polarizer 60 and the TFT substrate 10, thereby increasing the visual range of the user and optimizing the user experience.

In FIG. 1 and FIG. 2, the bonding end 10-1 is laminated with an anisotropic conductive film. One end of the COF 80 is electrically connected to the conductive terminals of the bonding end 10-1 through the anisotropic conductive film, and the other end of the COF 80 is electrically connected to a printed circuit board (PCB) 90.

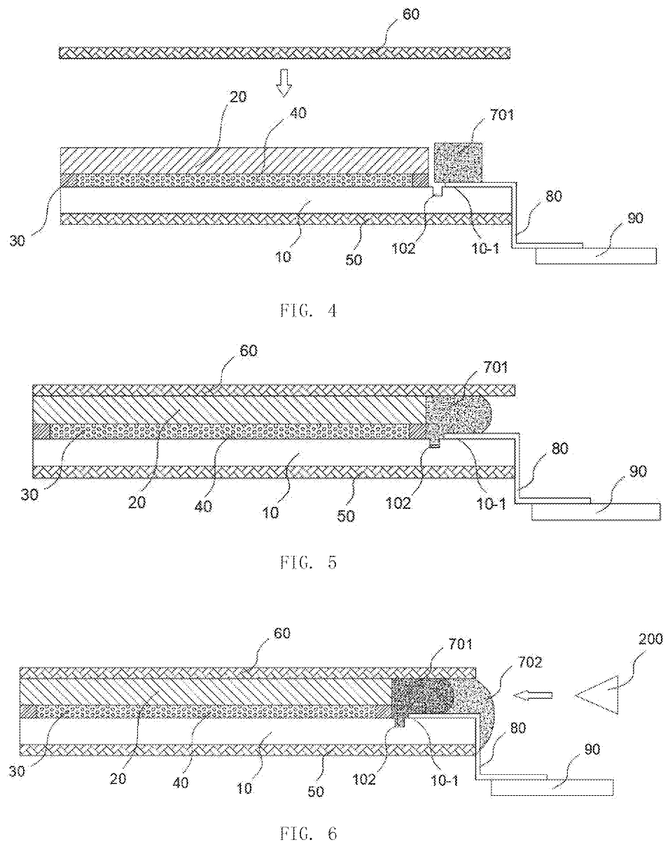

Based on the structure of the LCD panel of the embodiment 1, this embodiment made improvements to the manufacturing process of the LCD panel. The manufacturing process of the LCD panel according to the embodiment 1 is now described in reference to FIG. 1, FIG. 2, and FIG. 3, in which the manufacturing process includes the steps of:

S1: cutting a mother plate to form a liquid crystal cell, in which a salient portion of a TFT substrate of the liquid crystal cell forms a bonding end 10-1;

S2: electrically connecting the COF 80 to the bonding end 10-1;

S3: adhering the first polarizer 60 to an outer surface of the CF substrate 20 so as to form a cavity between the first polarizer 60 and the bonding end 10-1;

S4: laterally sealing the cavity and the side of the bonding end 10-1;

The manufacturing process of LCD panel consists of the array process as the front-end process, the cell process as the middle-end process, and the module process as the back-end process. The step of cutting the mother plate in step S1 is based on the array process and the process for laminating the TFT substrate 10 with the CF substrate 20 in the cell process. The CF substrate 20 is externally disposed to form the mother plate, which is further cut according to the desired dimension. Prior to the cutting, the position and quantity of the side of the TFT substrate 10 extending beyond CF substrate 20 must be taken into consideration. Also, the position of the bonding end 10-1 must be determined, and the width of the bonding end 10-1 extending beyond the CF substrate must be determined.

Concretely speaking, the bonding end 10-1 is laminated with an anisotropic conductive film. The COF 80 is electrically connected to the conductive terminals of the bonding end 10-1 through the anisotropic conductive film.

Concretely speaking, the shape and dimension of the first polarizer which is adhered in the step S3 is completely conformable to the TFT substrate 10. Before the adhering step, each side and corner of the first polarizer 60 are aligned with the TFT substrate 10 to ensure that the first polarizer 60 can completely covers the TFT substrate 10. By locating the bonding end 10-1 at an appropriate position on the TFT substrate 10, a cavity having an opening is formed between the first polarizer 60 and the bonding end 10-1 and formed between the sealing adhesive 30 and the side of the CF substrate 20.

Concretely speaking, as the bonding end 10-1 in the cavity is provided with metal wires mounted thereon, the cavity having an opening must be filled with adhesive in order to block the reflection and encapsulate the sides of the LCD panel. The filling process can be accomplished by laterally injecting a second sealing adhesive. During the filling process, the sealing adhesive can be extended to enclose the COF 80 close to the side of the bonding end 10-1. This can provide a certain level of protection for the COF 80 and smooth the ornamental contour of the LCD panel after the lateral sealing process is completed.

### Embodiment 2

In case that the bonding end 10-1 of the TFT substrate 10 has a larger width, the filling method discussed in the embodiment 1 is not able to fill up the cavity between the first polarizer 60 and the bonding end 10-1. Hence, this embodiment is proposed to make improvements to the filling method of the embodiment 1. This embodiment is different from the embodiment 1 in terms of the filling method of the sealing adhesive. As to the structural features, the structure of the LCD panel of this embodiment can be inferred from the embodiment 1, and it is not intended to give details herein.

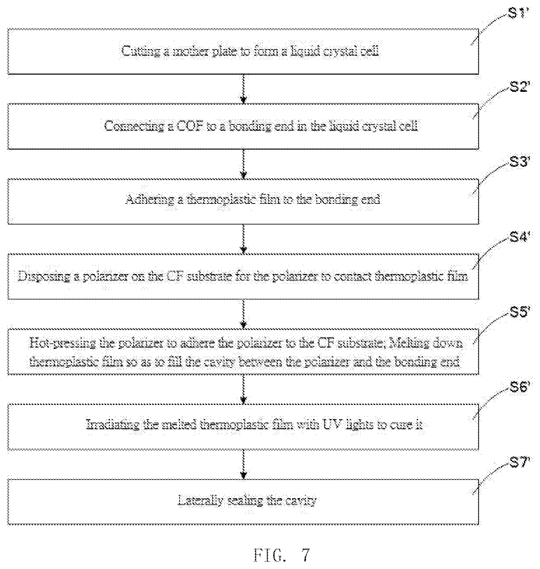

Concretely speaking, please refer to FIG. 4, FIG. 5, and FIG. 6. In the embodiment 2 the filling method for the cavity in the LCD panel is carried out as follows. First, the melting down and filling process of the first sealing adhesive 701 is executed. That is, before adhering the first polarizer 60 to the CF substrate 20, a thermoplastic film is adhered to the bonding end 10-1, and then a hot-pressing process is executed when the first polarizer 60 is adhered, so as to melt down the thermoplastic film and cure the melted thermoplastic film. Thus, a first sealing adhesive 701 is formed and filled in the cavity. After the foregoing filling process is completed and the first polarizer 60 is adhered, a second sealing adhesive 702 is injected into the cavity through the side of the LCD panel by a panel edge coater 200, thereby accomplishing the filling and sealing process. Furthermore, the second sealing adhesive 702 may be extended to enclose the portion of the COF 80 close to the end of the bonding end 10-1, so as to provide a certain level of protection for the COF 80. By melting down the thermoplastic film and filling the cavity with the melted thermoplastic film to accomplish the lateral sealing process, this packaging process can ensure the cavity between the TFT substrate 10 and the first polarizer 60 to be filled up. This can attain a solid filling effect and suppress the generation of bubbles without the requirement of high preciseness, and thus can promote the yield of the products.

In this embodiment, the thermoplastic film is melted down to form a sealing adhesive. The thermoplastic film may be disposed inside the groove 102 or disposed on the top surface of the groove 102, so that the melted thermoplastic film can enter the groove 102 after the thermoplastic film is melted down.

Based on the structure of the LCD panel of the embodiment 2, this embodiment made improvements to the manufacturing process of the LCD panel. The manufacturing process of the LCD panel according to the embodiment 2 is now described in reference to FIG. 4, FIG. 5, FIG. 6, and FIG. 7, in which the manufacturing process includes the steps of:

S1′: cutting a mother plate to form a liquid crystal cell, in which a salient portion of a TFT substrate of the liquid crystal cell forms a bonding end 10-1;

S2′: electrically connecting the COF 80 to the bonding end 10-1;

S3′: adhering a thermoplastic film to the bonding end 10-1;

S4′: disposing a first polarizer 60 on the CF substrate 20 to enable the first polarizer 60 to contact the thermoplastic film;

S5′: vacuum hot-pressing the first polarizer 60 to adhere the first polarizer 60 to an outer surface of the CF substrate, while melting down the thermoplastic film so as to fill a cavity between the first polarizer and the bonding end;

S6′: irradiating the filled thermoplastic film so as to cure the filled thermoplastic film; and

S7′: laterally sealing the cavity and the side of the bonding end.

The manufacturing process of LCD panel consists of the array process as the front-end process, the cell process as the middle-end process, and the module process as the back-end process. The step of cutting the mother plate in step S1 is based on the array process and the process for laminating the TFT substrate 10 with the CF substrate 20 in the cell process. The CF substrate 20 is externally disposed to form the mother plate, which is further cut according to the desired dimension. Prior to the cutting, the position and quantity of the side of the TFT substrate 10 extending beyond CF substrate 20 must be taken into consideration. Also, the position of the bonding end 10-1 must be determined, and the width of the bonding end 10-1 extending beyond the CF substrate must be determined.

Concretely speaking, in the step S3′ the thermoplastic film is adhered to the bonding end 10-1. It can be understood that the connection of the COF 80 has been completed before the thermoplastic film is adhered. Such connection would take wider area. Hence, when it is desired to adhere the thermoplastic film, the thermoplastic film may be directly adhered to the top surface of the COF 80 as the thermoplastic film has a certain width. Certainly, the thermoplastic film may be adhered to the boding end 10-1 at the position where COF 80 is not connected thereto.

Likewise, when the bonding end 10-1 is provided with a groove for the purpose of secure connection, the step S3′ may be altered depending on the structure. For example, the thermoplastic film may have adhered to the inside of the groove 102 and/or adhered to the top surface of the groove 102 depending on the width of the groove 102 and the shape and dimension of the thermoplastic film. This serves the purpose of finally disposing the cured sealing adhesive in the groove 102 to securely connect the first polarizer 60 to the TFT substrate 10.

In order to allow the melted thermoplastic film to fill up the interior of the cavity as best as possible, the thermoplastic film may be adhered to the interior of the cavity at the position close to the bonding end 10-1 during the adhering process of the thermoplastic film.

Concretely speaking, after the thermoplastic film is adhered, the first polarizer 60 is required to be adhered. It is desirable to adhere a second polarizer 50 to the outer surface of the TFT substrate 10 before the step S4′. The second polarizer 50 may be completely adhered to the outer surface of the TFT substrate 10.

Concretely speaking, in the step S4′ the first polarizer 60 is disposed on the CF substrate 20 to enable the first polarizer 60 to contact the thermoplastic film. In this step, because the thermoplastic film is partially adhered, and the cavity and the groove 102 must be filled with the melted thermoplastic film, the surface of the thermoplastic film must protrude from the top surface of the CF substrate 20. Under this condition, the first polarizer 60 on the CF substrate 20 is in contact with the top surface of the adhered thermoplastic film.

Concretely speaking, in the step S5′ the first polarizer 60 is vacuum hot-pressed and thus the thermoplastic film in contact with the first polarizer 60 is melted, so that the first polarizer 60 moves downwards and adheres to the outer surface of the CF substrate 20. The melted thermoplastic film starts to fill the cavity between the first polarizer 60 and the TFT substrate 10, thereby starting to partially seal the LCD panel and partially shading the metal wires on the bonding end 10-1. The position to which the vacuum hot-pressing operation is applied is the position on the first polarizer 60 opposite to the thermoplastic film. That is, only the position to which the thermoplastic film is adhered is heated.

In the step S6′, the irradiation of the UV lights can be accomplished by irradiating the melted thermoplastic film through the side of the LCD panel and thus curing the melted thermoplastic film.

In the step S7′, the sealing process can be carried out according to the sealing process discussed in embodiment 1 to further seal the cavity.

The thermoplastic film is an UV cured adhesive product that has an excellent adhesion to glass materials. The neutral ingredients of the thermoplastic film do not etch off ITO (indium tin oxides, wherein an ITO thin film is a transparent conductive film consisting of ITO semiconductor) and polarizers. Prior to UV irradiation process, the side of the film which is close to the light is absorbed and can be easily tom off. After the curing process, the film is quite stable and has good adhesion and low shrinkage. After the film is processed with UV irradiation process, its adhesion is strengthened and is durable against heat and moisture. The film is featured by pre-heating mold ability with a molding temperature of 60° C. The thermoplastic film is highly moldable and has a good filling property. By adhering the thermoplastic film to the cavity between the TFT substrate 10 and the first polarizer 60 and hot pressing the thermoplastic film, the thermoplastic film is able to fill the cavity.

The LCD panel proposed by the invention takes the polarizer on the CF substrate as the viewing plane and locate the bonding end on the LCD panel between the polarizer and the TFT substrate. The sealing adhesive obtained by melting down a thermoplastic film or the second sealing adhesive is laterally injected to fill the between the polarizer and the TFT substrate. This would eliminate the need of arranging a bezel to shade the bonding end and thus achieve a bezel-less LCD panel. As a result, the overall visual effect and viewing experience is enhanced. Meanwhile, in case that a LCD panel of the same width is used, the arrangement of the groove can tighten the fastening between the polarizer and the TFT substrate. The manufacturing process of the invention is featured by connecting the bonding end of the TFT substrate to the COF and then adhering the polarizer to the outer surface of the external CF substrate. Thus, it is not required to dispense and fill adhesive to the bare bonding end. Therefore, the manufacturing cost is reduced and the printing process due to the external TFT substrate is omitted, thereby simplifying the manufacturing process.

The concrete embodiments of the invention have been elaborated above. It is to be stressed that several modifications and alterations can be made by an artisan skilled in the art without departing from the principles of the invention. These modifications and alterations should be deemed to be fallen within the scope of the invention.

What is claimed is:

1. A The liquid crystal panel, comprising:
a thin-film transistor (TFT) substrate;
a color filter (CF) substrate disposed on the TFT substrate;
Liquid crystals filled between the TFT substrate and the CF substrate; and
a first polarizer adhered to an outer surface of the CF substrate;
wherein at least one end of the TFT substrate extends beyond one end of the CF substrate to form a bonding end for connecting to a chip on film (COF);
wherein the first polarizer completely covers the TFT substrate, and a sealing adhesive is provided between the first polarizer and the bonding end and to a side surface of the bonding end; and
wherein a portion of the COF close to the side surface of the bonding end is enclosed in the sealing adhesive.

2. The liquid crystal panel according to claim 1, wherein the sealing adhesive includes a first sealing adhesive formed by melting down a thermoplastic film and/or a second sealing adhesive which is laterally injected by a panel edge coater.

3. The liquid crystal panel according to claim 1, wherein a surface of the bonding end opposite to the first polarizer is provided with a groove, in which the sealing adhesive is filled therein.

4. The liquid crystal panel according to claim 3, wherein the sealing adhesive includes a first sealing adhesive formed by melting down a thermoplastic film and/or a second sealing adhesive which is laterally injected by a panel edge coater.

5. The liquid crystal panel according to claim 3, wherein the bonding end is laminated with an anisotropic conductive film, and the COF is electrically connected to conductive terminals of the bonding end through the anisotropic conductive film.

6. The liquid crystal panel according to claim 5, wherein the sealing adhesive includes a first sealing adhesive formed by melting down a thermoplastic film and/or a second sealing adhesive which is laterally injected by a panel edge coater.

7. A manufacturing method for a LCD panel, comprising the steps of:
cutting a mother plate to form a liquid crystal cell, wherein a salient portion of a thin-film transistor (TFT) substrate of the liquid crystal cell forms a bonding end;
electrically connecting a chip on film (COF) to the bonding end;
adhering a first polarizer to an outer surface of a color filter (CF) substrate so as to form a cavity between the first polarizer and the bonding end; and
laterally sealing the cavity and a side of the bonding end.

8. The manufacturing method according to claim 7, wherein the step of laterally sealing is accomplished by laterally injecting a second sealing adhesive by a panel edge coater.

9. A manufacturing method for a LCD panel, comprising the steps of:
cutting a mother plate to form a liquid crystal cell, wherein a salient portion of a thin-film transistor (TFT) substrate of the liquid crystal cell forms a bonding end;
electrically connecting a chip on film (COF) to the bonding end;
adhering a thermoplastic film to the bonding end;
disposing a first polarizer on a color filter (CF) substrate to enable the first polarizer to contact the thermoplastic film;
vacuum hot-pressing the first polarizer to adhere the first polarizer to an outer surface of the CF substrate, while melting down the thermoplastic film so as to fill a cavity between the first polarizer and the bonding end;
irradiating the filled thermoplastic film with UV light so as to cure the filled thermoplastic film; and
laterally sealing the cavity and a side of the bonding end.

10. The manufacturing method according to claim 9, wherein the step of laterally sealing is accomplished by laterally injecting a second sealing adhesive by a panel edge coater.

11. The manufacturing method according to claim 9, wherein before the step of vacuum hot-pressing, a surface of the thermoplastic film protrudes from a surface of the CF substrate.

12. The manufacturing method according to claim 11, wherein the step of laterally sealing is accomplished by laterally injecting a second sealing adhesive by a panel edge coater.

13. The manufacturing method according to claim 11, wherein the thermoplastic film is set to melt down to form a first sealing adhesive.

14. The manufacturing method according to claim 13, wherein the step of laterally sealing is accomplished by laterally injecting a second sealing adhesive by a panel edge coater.
